(19) United States
(12) Patent Application Publication
(10) Pub. No.: US 2006/0042618 A1
(43) Pub. Date: Mar. 2, 2006

(54) Aromatic barbeque charcoal kit

(76) Inventor: Henry J. Gonzalez, Upland, CA (US)

Correspondence Address: SHUMAKER & SIEFFERT, P. A., 8425 SEASONS PARKWAY, SUITE 105, ST. PAUL, MN, 55125, US

(21) Appl. No.: 10/926,367

(22) Filed: Aug. 25, 2004

(51) Int. Cl. A21B 1/08

(52) U.S. Cl. 126/20

(57) ABSTRACT

A pre-packaged barbeque kit, including wood charcoal pieces and accelerant is described. Additionally, a method of preparing to barbeque is described, which includes opening a pre-packaged barbeque kit including wood charcoal pieces and accelerant, preparing the accelerant for use, arranging the wood charcoal pieces, and lighting the accelerant.

### TECHNICAL FIELD

This invention relates to cooking, more specifically to barbequing.

### BACKGROUND

Barbequing has become a popular way of cooking food, as well as a hobby for many individuals. Barbequing may be done over many types of heat sources. Common heat sources include gas or charcoal briquettes. However, grilling using gas or plain charcoal briquettes does not impart an aromatic flavor to the food being prepared. Accordingly, barbeque sauces with a variety of flavors have been produced and sold. These sauces are usually applied directly to the food being prepared. However, the taste imparted by such sauces lacks richness.

Using an aromatic wood as part of the heat source is one manner of imparting an additional flavor to the prepared food. There are several varieties of aromatic wood that will impart aromatic flavor to the food being cooked. Examples of such woods include mesquite, hickory, apple, cherry, pecan, maple, peach, pear, alder, and other woods. Such woods have been used to cook the sample directly or mixed with charcoal. However, there are problems with such methods.

When the wood is used alone, it combusts rapidly, which causes a great amount of smoke, flame, and heat. This makes the cooking area unpleasant, and often has a bad effect on the food being prepared, which may include burning the outside of the food while not sufficiently cooking the inside. Another option has been to use pieces of aromatic woods together with slower burning fuels such as charcoal. However, the wood portion of the mixture still rapidly combusts, causing an excessive initial amount of smoke and heat. Though not as dense or hot as using only wood, the area immediately surrounding the barbeque area will still be uncomfortable and at odds with the enjoyment of the cooking process. Additionally, this rapid combustion means that the aromatic wood will burn out quickly, usually long before the food has been fully prepared.

Using wood charcoal has many advantages over using the wood directly. The heat emanating from the wood charcoal is more even and constant than that from wood. Additionally, the area around the cooking location is much more enjoyable when the wood charcoal is used. This enables the cooking process to be more enjoyable, and also results in a better cooked product.

Although aromatic woods are generally available, aromatic wood charcoal is not as readily available. Individually creating wood charcoals from the wood is also beyond the interest and often the capability of individuals.

When cooking with gas the gas source, or heated artificial briquettes, rocks, or other material, the heat source is generally positioned at a constant distance from the food cooking surface. This is also true for the majority of charcoal briquettes, which are formed into uniform sizes. However, when using aromatic woods or aromatic wood charcoal, sizing may become a difficult issue. With non-uniform sizing, the temperature and distance from the heat source becomes very non-uniform across the cooking surface, with corresponding negative effects on the food being prepared.

### SUMMARY

Accordingly, there exists a need for a readily available aromatic charcoal which meets the needs of the recreational barbequer, as well as the individual looking for a different barbeque experience.

These identified needs are met by the various aspects of the invention, as described more fully herein.

One aspect of the invention is a pre-packaged barbeque kit, including wood charcoal pieces and an accelerant.

Another aspect of the invention is a method of preparing to barbeque, which includes opening a pre-packaged barbeque kit including accelerant and wood charcoal pieces, preparing the accelerant for use, arranging the wood charcoal pieces, and lighting the accelerant.

Another aspect of the invention is a pre-packaged barbeque kit, including aromatic wood charcoal pieces, flavored oil, a towel, a match, and packaging.

The details of one or more embodiments of the invention are set forth in the accompanying drawings and the description below. Other features, objects, and advantages of the invention will be apparent from the description and the claims.

### DETAILED DESCRIPTION

In one aspect, the invention features a pre-packaged barbeque kit, which includes wood charcoal pieces and an accelerant. This pre-packaged kit makes the barbeque preparation less laborious and more enjoyable. This allows the focus of barbequing to be on the food being prepared and the experience of barbequing.

Wood charcoal pieces, as used herein, means wood that has been carbonized into a charcoal form but still retains roughly the original shape, wood grain, and general appearance of the wood used, and has not been compressed, shaped, or formed. Generally, the wood will be cut to a desired size before being turned to charcoal. However, large charcoal pieces may be cut to the proper size after the charcoal process. The wood charcoal pieces are not compressed or formed into a pre-determined shape, but retain the natural grain and shape of the wood used.

These wood charcoal pieces may be made from any wood type, but preferably are made from an aromatic wood. Examples of aromatic woods include mesquite, hickory, apple, cherry, pecan, maple, peach, pear, and alder. Aromatic woods are then turned to wood charcoal by a process including heat and a lack of oxygen. There are two basic methods of making charcoal, a direct method and an indirect method.

The direct method uses heat from the incomplete combustion of the wood to turn the wood into charcoal. The rate of combustion is controlled by the amount of oxygen present, and the combustion is ended by completely excluding oxygen once the wood has turned to charcoal, but before the charcoal begins to burn. The indirect method uses an external heat source to carbonize the wood into charcoal. The wood is contained in a nearly closed but vented, almost airless chamber. The rate of combustion is controlled by the amount of heat applied, and as the chamber is nearly entirely free of oxygen throughout the process, the process ends when heating ends. Wood charcoals may be made using either process and from any wood. Preferably, the wood charcoal used will be made from a direct process, using a kiln. Preferably the wood charcoal will be made from an aromatic wood. More preferably, the wood charcoal will be made from mesquite wood.

The wood charcoal may come in a variety of sizes. Preferably, the wood charcoal will be of a proper size to use for individual and residential use, and accordingly selected to be the proper size for easy lighting, heating, and cooking in the average and usual barbeque. Examples of such barbeques may be found at any number of stores including Home Depot, Sears, and others. Additionally, such wood charcoals could also be used in grills found in parks, as well as on the ground with a grill over them. Basically, the wood charcoal could be used in any situation in which wood or charcoal would be used.

For improved cooking performance, the wood charcoal will preferably be of a more or less uniform size. The preferred size of the wood charcoal pieces is to be about 1 inch to about 2.5 inches in thickness, from about 2 inches to about 5 inches in length, and from about 1.5 to about 3 inches in width. More preferably, the wood charcoal pieces will be from about 1.25 to about 2 inches in thickness, from about 2.5 to about 4 inches in length, and from about 1.75 to about 2.5 inches in width. The average weight of such pieces is between about 2 ounces and about 4 ounces. The general uniformity of the wood pieces enables a more consistent performance when used in barbequing and cooking. The general uniformity enables the cooking surface to have a consistent level of heat reaching the food being prepared and allows for more enjoyable barbequing and eating.

Although the wood charcoal generally burns hot and clean, the barbeque kit may include an accelerant to assist in starting the wood charcoal burning. The accelerant may be a solid or a liquid, and may be packaged in any type of packaging materials including glass, plastic, and paper. The accelerant packaging may also be combustible. Preferably, the accelerant will be a liquid.

If the accelerant is a liquid, it may be applied to a towel, which may be included as part of the kit. This combination may be used as the ignition source for the wood charcoal pieces. When using charcoal briquettes, a traditional charcoal lighting fluid is often used, which may be dangerous. Additionally, the use of many lighter fluids is restricted in some locations because of the volatile organic components they contain. Lastly, traditional lighter fluid can impart an undesirable taste to the food being prepared.

If used, the towel will be part of the ignition source, and accordingly should be flammable to assist in lighting the charcoal. Additionally, the ease of cleanup is improved if the towel is combusted. The material selected should not impart a poor smell or flavor to the food being prepared, or to the area surrounding the cooking area. The towel may be made of a number of materials, for example, cotton, flax, or paper. Any material that is combustible and absorbent would be appropriate. The importance of the towel is to absorb accelerant and to keep the accelerant in place and not allow the accelerant to leak out. Preferably, the towel will be made of paper, cotton, or a combination of the two. More preferably, the towel will be made of paper. The towel may be folded in such a manner to assist in applying and soaking in the accelerant. For example, the towel may be folded into roughly a square, and then opened in such a manner that the towel resembles a pocket. The accelerant may then be poured into the pocket area, which decreases the likelihood of spilled accelerant.

Alternatively, the accelerant may be poured directly over the charcoal pieces, without the use of a towel to hold the accelerant. The wood charcoal pieces may be arranged in the barbequing area, and the accelerant poured over the arranged charcoal. Optionally, a towel may placed beneath the wood charcoal pieces. Alternatively, the accelerant may be poured over the wood charcoal pieces prior to placement into the barbequing area.

The accelerant used should not impart a poor smell or flavor to the food being prepared, or to the area surrounding the cooking area. Additionally, it should be easy and safe to use. Therefore, the preferred accelerant will be oil. As the oil used is part of the ignition source, it accordingly should burn fast enough and at a proper temperature to cause the charcoal to be lit and begin to burn. Examples of oils that can be used include cooking oils, sunflower oil, canola oil, safflower oil, vegetable oil, olive oil, and rice oil. Preferably, the oil used will be a vegetable oil of some type.

In order to add additional flavor to the food being prepared, to add ambiance to the cooking area, or to enhance the enjoyment of the cooking process, the oil may be flavored. Examples of possible flavors include, but are not limited to, garlic, ginger, pepper, lemon, and lime. This flavoring may be pre-mixed into the oil, may be added to the oil later, or may be added separately to the towel used.

Optionally, the oil used may be colored. This can help by visually showing the oil in order to see the oil as it is applied, will assist in finding any possible spills, and in visualizing how the oil is spread across and into the towel used.

Alternatively, a solid accelerant source may be used. This solid accelerant could be formed, for example, of waxes, or waxes mixed together with wood shavings. This solid material should be easy to light and burn hotly in order to assist in lighting the charcoal. The solid accelerant may be placed beneath or in the middle of arranged wood charcoal pieces. Alternatively, such an accelerant may sprinkled over the wood charcoal pieces, stretched across them, placed beneath them, or set through arranged wood charcoal pieces.

Alternatively, the accelerant may be added to the aromatic wood charcoal some time prior to actual use. For example, the accelerant may be applied to the aromatic wood charcoal prior to packaging in the kit. This would enable to user to remove the aromatic wood charcoal pieces from the kit directly for use in the barbeque, and would not require additional time or effort to apply accelerant at that time. An example of a suitable method includes the aromatic wood charcoal pieces saturated in oil, dried, and then packaged for use. Additionally, flavorings may be applied to the aromatic wood charcoal pieces some time prior to use. For example, the flavorings may be applied prior to packaging, so that the pieces can be used directly without additional steps by the user. This would enable the kit to contain fewer items and improve ease of use while still providing a full and complete flavored aromatic wood barbeque experience when used.

The barbeque kit may optionally include a combustion source. Examples of such sources include, but are not limited to matches, flint and steel, and a gas lighter. Preferably, the combustion source will be matches. Most preferably, the combustion source will be wood matches. The combustion source is used to ignite the accelerant, which will in turn, ignite the wood charcoal. Thereafter, barbequing may proceed as desired.

Additionally, the barbeque kit may be enclosed in an outside package. This packaging may be made of paper, plastic, cardboard, cloth, or other packaging material. The importance of the packaging is that it be strong enough to withstand ordinary shipping, handling, and storage while protecting the contents, especially the charcoal. The charcoal is hard, yet brittle, so pieces may be broken off by rough handling. The uniform sizing is important, as this enables stacking the wood charcoal pieces for easy lighting, and also enables the charcoal, when spread, to be of roughly equal distance from the food being prepared. Therefore, the charcoal is packed within the barbeque kit packaging in such a manner so as to be protected. This packing may include the use of dividers within the package to further protect and support the charcoal pieces. The packaging may include other features to assist the user. For example, the package may include a handle, an area for lighting matches, or instructions and descriptions.

The barbeque kit may also include other items, for example, instruction sheets, directions, recipes, advertising, reply cards, bubble wrap for additional protection, additional dividers, spice packages, and paper bags for ashes. Instructions may optionally be included in the kit, or on the packaging, with written or pictorial instruction showing how the kit is to be used. The kit may have one or more handles to make moving the kit easier. If present, handles may be made out of cardboard, plastic, rope, or other suitable material.

Various kit sizes may be made. One size contains enough wood charcoal pieces (about ten pounds) for two average barbeques. Other sizes of packaging may also be used, for example, small packages to be used for hibachi barbeques, and large packages for larger gatherings.

Generally, the pre-packaged barbeque kit described above will be opened. The accelerant included in the kit will be pulled from the kit after opening. If it is a liquid accelerant, the container will be opened, and the accelerant may be poured onto a towel or distributed across the towel. This towel may be included as part of the kit, but need not be. There may be one or more towels used. The towels may be folded a number of times and formed into a pocket for an area into which the oil may be poured. The towel may then be placed into the area prepared for cooking or barbequing. The wood charcoal will then be placed upon it. The wood charcoal may be placed in any fashion, but preferably will be placed in a manner to assist in the lighting and burning of the wood charcoal. Examples of such preferred placements include a pyramid and a cube. The combustion source may then be used and the towel lit on fire.

In another aspect, the kit may be opened and the solid accelerant removed and placed into the area prepared for barbequing. This may be done in conjunction with some charcoal pieces. Additional wood charcoal pieces may then be placed upon and/or around the solid accelerant. The wood charcoal may be placed in any fashion, but preferably will be placed in a manner to assist in the lighting and burning of the wood charcoal. Examples of such preferred placements include a pyramid and a cube. The combustion source may then be used and the solid accelerant lit on fire. This combustion source may be part of the kit, but need not be.

Alternatively, a kit may be opened in which the accelerant has been pre-dispersed on the wood charcoal pieces. The accelerant will be prepared for use by transferring the wood charcoal pieces to the barbeque area. The wood charcoal pieces will then be arranged, such as, for example, in the shape of a cube, pyramid, or pile. Then, the accelerant on the wood charcoal pieces will be lit, lighting the wood charcoal. Again, the combustion source used may be part of the kit, but need not be.

### EXAMPLES

One example of barbeque kit uses cardboard as the packaging material. The cardboard is folded into a box in which the lid folds into the bottom of the box. The outside dimensions are approximately 18 ¼ inches long, 4 ½ inches high, and 10 ¼ inches wide. The box also has a cardboard handle which folds out from the long side of the box near where the lid folds into the bottom of the box. The box also has a roughened area which may be flint or sandpaper near the handle, which may be used for striking matches. The wood charcoal is placed within the box in two layers, with a cardboard divider between the layers. Such a packaging container encloses enough wood charcoal (about ten pounds) to be used for two average barbeques, or one large barbeque. Also included in the kit are instructions, two paper towels, several wooden matches, and a container of vegetable oil.

One example of using a kit is that the kit is taken to the barbequing area and opened. Some aromatic wood charcoal is removed from the kit and placed into the barbequing area. Two paper towels are taken from the kit. These towels are folded in eighths, and then opened into a pocket. The container of flavored vegetable oil is opened and the oil poured into the paper towel pocket. The paper towel pocket is placed with the charcoal pieces in the grill so that the pocket remains upright. Additional aromatic wood charcoal pieces are taken from the kit and stacked in the barbequing area so that all the pieces are stacked in a roughly pyramidal shape to assist in lighting and burning. Roughly one layer of aromatic wood charcoal pieces from the kit have been used. The matches are then removed from the kit and one match is struck on the roughened area of the kit box to light the match. The lit match is used to light the paper towel and oil pocket, which in turn causes the aromatic wood charcoal pieces to begin burning. After the charcoal pieces have been burning for a while and have become hot, the pieces are spread, a grill is placed over the pieces, and the food may be placed upon the grill for cooking.

A number of embodiments of the invention have been described. Nevertheless, it will be understood that various modifications may be made without departing from the spirit and scope of the invention. Accordingly, other embodiments are within the scope of the following claims.

What is claimed is:

1. A pre-packaged barbeque kit, comprising:
wood charcoal pieces; and
an accelerant.

2. The kit of claim 1, further comprising one or more towels.

3. The kit of claim 2, wherein said one or more towels are made of paper.

4. The kit of claim 1, wherein said wood charcoal pieces are aromatic wood charcoal pieces.

5. The kit of claim 4, wherein said wood charcoal pieces are mesquite wood charcoal pieces.

6. The kit of claim 1, wherein said wood charcoal pieces weigh between about 2 oz. and about 4 oz.

7. The kit of claim 1, wherein said wood charcoal pieces are from about 1 inch to about 2.5 inches in thickness, from about 2 inches to about 5 inches in length, and from about 1.5 to about 3 inches in width.

8. The kit of claim 7, wherein said wood charcoal pieces are from about 1.25 to about 2 inches in thickness, from about 2.5 to about 4 inches in length, and from about 1.75 to about 2.5 inches in width.

9. The kit of claim 1, wherein said accelerant is an oil.

10. The kit of claim 9, wherein said oil is flavored.

11. The kit of claim 9, wherein said oil is colored.

12. The kit of claim 1, wherein said accelerant is a solid.

13. The kit of claim 1, further comprising an ignition source.

14. The kit of claim 1, further comprising packaging.

15. The kit of claim 1, wherein said accelerant has been dispersed on the wood charcoal pieces.

16. A method of preparing to barbeque, comprising:
opening a pre-packaged barbeque kit comprising wood charcoal pieces and accelerant;
preparing the accelerant for use;
arranging the wood charcoal pieces; and
lighting the accelerant.

17. The method of claim 16, wherein preparing the accelerant for use comprises:
opening a packaged liquid accelerant;
pouring the packaged liquid accelerant into or onto a towel; and
placing the towel into an area prepared for barbequing.

18. The method of claim 17, wherein said liquid accelerant is oil.

19. The method of claim 18, wherein said oil is flavored.

20. The method of claim 16, wherein said wood charcoal pieces are aromatic wood charcoal pieces.

21. The method of claim 16 wherein preparing the accelerant for use comprises:
taking a solid accelerant; and
placing the solid accelerant into an area prepared for barbequing.

22. A pre-packaged barbeque kit, comprising:
aromatic wood charcoal pieces;
flavored oil;
a towel;
a match; and
packaging.
